(19) United States
(12) Patent Application Publication
(10) Pub. No.: US 2024/0233447 A1
(43) Pub. Date: Jul. 11, 2024

(54) METHOD OF DIAGNOSING CRANE ACTIVITY TO DETERMINE ANOMALIES CAUSING A DROP IN ACTIVITY

(71) Applicant: MANITOWOC CRANE GROUP FRANCE, DARDILLY (FR)

(72) Inventor: Xavier CLAEYS, LYON (FR)

(21) Appl. No.: 18/410,996

(22) Filed: Jan. 11, 2024

(30) Foreign Application Priority Data
Jan. 11, 2023 (FR) 2300284

(51) Int. Cl. G07C 3/08; B66C 15/00

(52) U.S. Cl. CPC G07C 3/08; B66C 15/00

(57) ABSTRACT

A diagnostic method for detecting and classifying a drop in activity period of a crane in a construction site among several activity periods, includes detecting crane data from its equipment which in particular comprise work data representative of a crane maneuver, and environmental data representative of the construction site environment. The method also includes, for each activity period, processing work data to determine whether the activity period is a drop in activity period or not, with in particular an analysis of the work time of the crane during this period, and for each drop in activity period, processing crane and environmental data associated with at least the drop in activity period to identify at least one anomaly explaining the drop in activity period.

### FIELD

The invention relates to a method for diagnosing a crane for an evaluation of its activity when used on a construction site.

It relates more particularly to a diagnostic method in which data relating to the crane and its environment are analyzed, making it possible to determine over time periods where the productivity/activity of the crane has dropped, and to identify the causes or anomalies at the origin of this drop in activity.

The invention thus finds a preferred application in the management of a construction project and the organization, both technical, human and material, of a construction site in which one or more cranes are used.

### BACKGROUND

In a known manner, understanding and analyzing the causes of schedule delays and drop in productivity on a construction site can be particularly complex due to the plurality of human and material actors that it can involve.

The drops in productivity/activity during the day of a crane used on this construction site can come from numerous sources, both internal and external to the crane. For example, a delay in a logistics operation or an extreme weather condition can result in the crane being stopped, regardless of its proper functioning. There are also other causes of a drop in activity, for example and not exhaustively: a breakdown due to a malfunction/stoppage of a crane equipment; a poorly optimized crane load plan (times when the crane is working, times when it is inactive, etc.); human error in its assembly, its setting or its handling, etc.

It is also known that a crane is equipped with a plurality of equipment necessary for its control, its operation; and also sensors providing various information on the crane itself or its environment, for example and not exhaustively: a lifting speed when the crane lifts a load, a rotation speed of a boom when it displaces the load, alerts when the boom of the crane risks colliding with the boom of a second crane, a number of starts and/or stops, a state of the equipment, etc.

In the literature, the documents US 2012/0158279 and US 2018/0018641 propose to exploit the data provided by the equipment of a machine, such as a crane, with the aim of providing performance indicators on it or ensure predictive maintenance (by predicting the lifespan of components in order to carry out actions following it, such as renewing a component if it is at the end of its life). The documents CN107025521 and DE102015006992 propose to use equivalent data with the aim of respectively providing an optimized work plan for the crane, and optimizing the capacities of the crane according to the intensities of its demands to avoid any overload situation.

The document US2009/0055039 discloses an apparatus for establishing a diagnosis of a crane equipped with a lifting magnet for lifting magnetic loads, comprising a diagnostic panel at least in communication with a lifting magnet system which is designed to control the lifting magnet depending on the crane operator's control commands.

The state of the art can also be illustrated by the teachings of the document CN108190745 which discloses a data collection system receiving data from a plurality of pieces of equipment of a crane in order to determine, when analyzed, malfunctions or breakdowns of said pieces of equipment

However, none of these solutions propose to exploit the data provided by the crane with the aim of contextualizing the drops in activity of the crane and their repercussions on the general progress schedule of the construction site, both in terms of material and the human plane.

### SUMMARY

In order to respond to the exposed problem, the invention relates to a method for diagnosing an activity of a crane for a detection and a classification of a drop in activity period of said crane in a construction site among several activity periods, said diagnostic method implementing at least the following steps:
detecting crane data from crane equipment, and comprising at least work data representative of work of the crane implementing at least one maneuver of at least one structural element of the crane;
detecting environmental data representative of an environment of the construction site, and comprising at least climatic data;
logging by activity period of crane data and environmental data in a remote database;
for each activity period, processing the work data to calculate a work time of the crane during the activity period, and comparison of said work time with at least one activity threshold to determine whether said activity period is a drop in activity period or not;
for each drop in activity period, processing crane data and environmental data associated with at least said drop in activity period to identify at least one anomaly, of the construction site or of the crane, with which is associated said drop in activity period.

In other words, and advantageously, from:
data provided by the equipment that the crane comprises, and which are at least representative of the work of the latter when at least one of its structural elements is maneuvered (for example the block which is lifted when a load is lifted, or the arrow which rotates for the displacement of the load following its lifting), and
environmental data representative of the environment and the location of the construction site in which the crane operates,

which data are collected during one or more given activity periods (an activity period which can be for example a day, a week, a month) then stored and historicized by activity period (so that the data collected specific to each activity period can be identified) in the remote database,

the diagnostic method is capable of:
determining whether or not a drop in activity of the crane has occurred for at least one considered activity period. For this, the method calculates from the data representative of the work of the crane its activity time during the activity period, that is to say the total duration during this activity period where it was active; then compares this activity time to an activity threshold which can, for example, correspond to an average activity time objectively determined by the construction site managers; and
in the case of a detected drop in activity, determining and contextualizing the causes, subsequently designated as anomalies, at the origin of this drop in activity, allowing site managers to continuously improve the progress schedule for this on the material (with better management of equipment for example) and/or human and/or logistical/organizational levels.

According to a characteristic of the invention, the at least one anomaly comprises at least one internal anomaly of the crane reflecting a technical failure of the crane and identified from the crane data.

According to an embodiment of the invention, the at least one internal anomaly comprises at least one hardware, software or communication fault in one of the equipment called faulty equipment, identified from crane data from said faulty equipment.

In other words, the diagnostic method is designed to determine whether the anomaly responsible for a drop in activity of the crane during a given activity period is caused by a technical failure of the latter which can be caused non-exhaustively by: a malfunction or breakdown of one or more of these components and equipment; a software malfunction or breakdown, a communication problem between crane equipment/components, etc. This type of anomaly is determined by the diagnostic method using data provided for example by the equipment/components of the crane themselves, or by the fault manager thereof.

Advantageously, the identification of this anomaly allows the site manager to determine that the cause of the drop in activity of the crane comes from a failure of equipment on the machine itself, due for example to its lack of maintenance, a repair not carried out, or wear and tear on consumable equipment.

According to a characteristic of the invention, the at least one anomaly comprises at least one use anomaly reflecting non-compliant use of the crane and identified from the crane data.

According to an embodiment of the invention, the at least one use anomaly comprises at least one mounting anomaly reflecting a mounting, or an adjustment, or both, of equipment non-compliant or not suitable for the construction site, and identified from sensor data selected from crane data and coming from at least one sensor of the crane.

According to an embodiment of the invention, the at least one use anomaly comprises at least one control anomaly reflecting non-compliant control of the crane by a crane operator during maneuvers, and identified from the work data, such as for example speed data of at least one structural element of the crane or overload data.

In other words, the diagnostic method is designed to determine whether the anomaly responsible for a drop in activity of the crane during a given activity period is caused by an anomaly in use of the crane, not exhaustively:
inappropriate control of the crane by the crane operator (too quickly lifting/depositing of a load, too quickly rotation of the boom, etc.);
incorrect installation of the crane, and/or adjustment of its structural, functional or ballast elements. For example, in order to meet the specific needs of the construction site, particular adjustments must be made to the elements and equipment of the crane to perform additional functionalities. However, these adjustments may not have been anticipated before starting the construction site, implying that delays will occur at unwanted times during the life cycle of the site to make these adjustments, otherwise it will not be able to move forward.

The delays can also be caused by an unplanned change in the initial configuration of the construction site, with the emergence of new, previously unknown needs.

This type of anomaly is determined by the diagnostic method using crane data provided for example by equipment/components or crane sensors, for example: data on the location of structural, functional and ballast elements; load/overload data when lifting a load; speed data during the rotation of the boom, or speed or positioning data for the rise or fall of the block, etc.

Advantageously, the identification of this anomaly allows the site manager to determine that the cause of the drop in activity of the crane is not linked to the construction machine itself but to human errors, which must lead to the site manager to improve the organization of the site on a human level.

According to a characteristic of the invention, the at least one anomaly comprises at least one climatic anomaly reflecting an extreme and identified climatic condition from climatic data selected from environmental data.

According to a characteristic of the invention, the climatic data comprise at least one of the following data: temperature data, wind speed data and hygrometric data.

In other words, the diagnostic method is designed to determine whether the anomaly responsible for a drop in activity of the crane during a given activity period is caused by extreme climatic conditions, generally associated with bad weather, such as: very high or very low outdoor temperatures; very heavy rain; very strong gusts of wind. This type of anomaly is determined by the diagnostic method from environmental data such as temperature data, wind speed data and hygrometric data, which are provided by suitable measuring devices (such as outdoor temperature sensors, anemometers for measuring wind speed, etc.).

Advantageously, the identification of this anomaly allows the site manager to determine that the cause of the drop in activity of the crane is independent of the organization of the site (whether on the material, human, logistical level), and to adapt the activity of the site, and therefore of the crane accordingly, particularly if these climatic anomalies are recurrent: reduction of the activity of site workers during periods of high temperatures to prevent them from having an impact on their condition/health, put into weather vane of cranes if there is a risk of strong gusts of wind, etc.

According to a characteristic of the invention, the at least one anomaly comprises at least one organizational anomaly reflecting low profitability of the use of the crane and identified from the crane data.

According to an embodiment of the invention, the at least one organizational anomaly is identified from at least one of the following data among the crane data: data representative of a presence or activity of the crane operator in the crane, maneuver counting data, data representative of a stop controlled by an anti-collision system, cycle counting data load lifting, data representative of pause time between two maneuvers, data representative of types of maneuver, data representative of a type of crane.

In other words, the diagnostic method is designed to determine whether the anomaly responsible for a drop in activity of the crane during a given activity period is caused by a logistical problem) or an organizational lack in management of the construction site. The organizational lack can result, for example, in a crane that is inactive most of the time during the activity period and has very little, or in the worst case, no load to lift or displace. This type of anomaly is determined non-exhaustively from data representative of the presence or activity of a crane operator in the crane (the non-presence of a crane operator in the crane meaning that it is inactive, or it is present and performs few maneuvers and the pause time between each maneuver is important), load lifting cycle counting data, etc. The type of crane is also an important data because the usage guidelines are not the same between the types of crane and the context of the construction site environment (rapid assembly crane for individual constructions, assembly crane by elements or crane with automated assembly for the construction of buildings, etc.). The data representing a stop controlled by an anti-collision system are sources of information concerning sites comprising several cranes, in particular if the circular working areas of the cranes overlap: they make it possible to determine whether the risks of collision between crane booms or if the crane stops are too frequent, meaning that the cranes interfere with each other when carrying out their respective tasks.

Advantageously, the identification of this anomaly allows the site manager to determine that the cause of the drop in activity of the crane is linked to a logistical problem (which may or may not be the repercussion of another anomaly) or poorly optimized organization of the site activity, allowing it to offer suitable solutions. For example, in an application context in which a construction site would comprise several cranes among which one of them would be inactive most of the time, a possible solution would be a reallocation of tasks between the cranes, if the risks of interference between cranes remain low, and this does not significantly disrupt the construction progress schedule.

Similar to the first processing carried out to determine whether or not an activity period corresponds to a drop in activity period, the processing implemented to identify the type(s) of anomaly (internal anomaly, use anomaly, climatic anomaly, organizational anomaly) explaining the drop in activity consist first of all in applying to crane data and environmental data associated with this activity period mathematical algorithms which compare them to decision criteria perceptible/understandable by the analysts analyzing the activity period. Depending on the results of these comparisons, classification/categorization algorithms classify/arrange the drop in activity period in a category corresponding to one of the four types of cited anomaly, and also in a subcategory among several subcategories that the type (or category) of anomaly comprises. These subcategories correspond to the various events causing the anomaly. For example, and with reference to the explanations given previously, at least three subcategories are comprised in the category linked to the climatic anomaly; these three subcategories corresponding respectively to: extreme temperatures (high or low); heavy precipitation; and strong gusts of wind.

According to a characteristic of the invention, a remote analysis system, in communication with or comprising the remote database, implements the processing of work data, crane data and environmental data to determine whether each activity period is a drop in activity period or not and to associate with each drop in activity period the at least one corresponding anomaly.

In other words, the steps of processing the data associated with the at least one activity period to identify whether the at least one activity period is a drop in activity period or not, and to determine the anomaly type(s) explaining this drop in activity are carried out by a remote analysis system in communication with the remote database; this remote analysis system can be, for example, a laptop or desktop computer.

According to an embodiment of the invention, the remote database is comprised in the remote analysis system.

According to an embodiment of the invention, all or part of the processing is carried out by the remote analysis system directly in the remote database.

According to an embodiment of the invention, the analysis system exports from the remote database the work data, the crane data and the environmental data of the at least one considered activity period to carry out the processing.

According to a characteristic of the invention, the remote analysis system structures the crane data and the environmental data in a same predefined format.

Since work data, crane data and environmental data come from different equipment, the latter can be in different formats. For each activity period, before the data associated with each activity period are imported into the remote database, they are, once collected, transmitted to the remote analysis system which will clean and structure them according to a predefined format; with the aim of being more easily interpretable by the remote analysis system when it subsequently carries out processing on the data with a view to determine the drop in activity periods and their origins.

According to an embodiment of the invention, the diagnostic method implements, in parallel with the processing of crane data and environmental data for each drop in activity period, a display of a progress of said data processing for each drop in activity period.

According to a characteristic of the invention, the diagnostic method implements, subsequent to the processing of crane data and environmental data of each drop in activity period, a generation, or a display, or both, of an analysis report comprising, for the or each drop in activity period, an information specific to the at least one identified anomaly.

This generation and/or this display may take the form of a visual representation specific to the at least one identified anomaly; and/or a description of a set of processing steps carried out during the processing of the crane data and the environmental data which led to the identification of the at least one anomaly.

In other words, with the aim that the results of the processing can be easily interpretable and understandable for a person having implemented the diagnostic method in order to determine whether a crane on the site has experienced a drop in activity during an activity period and, if this is the case, determine the causes which are at the origin, the diagnostic method, according to different embodiments, can, following the processing of the crane data and the environmental data generate a display report in a given format that can be consulted later, and/or display this analysis report on a screen. In different embodiments of the invention, the analysis report may comprise:
a visual representation of at least one type/one category of anomaly identified for each of the activity periods which were the subject of the diagnosis, for example: a color, text giving the name of the anomaly and associated to a color, etc. By extension, it is possible that each subcategory of an anomaly type/category also has its own visual representation to improve understanding of the processing results; and/or
for the at least one anomaly identified for each drop in activity period, a detail of the processing carried out on the crane data, the work data, and the environmental data which led the diagnostic method to identify the at least one anomaly. By extension, it is possible that each subcategory comprised in the type/category of anomaly is accompanied by a description of the processing which specifically led the diagnostic method to identify this subcategory.

According to a characteristic of the invention, the diagnostic method comprises at least one definition of an additional anomaly and at least one decision criterion for an identification of the additional anomaly during the processing of crane data and environmental data.

Advantageously, the diagnostic method can be enriched and improved by informing/defining new anomalies, that is to say which have never been encountered on the construction site. The definition of the new anomaly consists at least of informing at least one decision criterion which will be applied by the diagnostic method during the processing of crane data and environmental data so that it identifies that the drop in activity is due to this new type of anomaly. By extension, the diagnostic method can also be enriched and improved by defining subcategories for this new type of anomaly representative of the causes generating it. Here again, for each subcategory, at least one decision criterion must be defined so that the diagnostic method can identify it during the processing. Possibly, the definition of a new anomaly may require an evolution of the format used for structuring the data, in the case where the anomaly is determined from data which are transmitted by one or more equipment in a format not currently supported for the structuring of all data (work data, crane data, environmental data) in a single format.

In a first variant of the invention, the anomaly definition additions are made from the remote analysis system by the users themselves.

In a second variant of the invention, the anomaly definition additions are made by the creators of the diagnostic method on the basis of customer experience feedback; the additions of anomaly definition are then part of an agile development approach for continuous improvement of the diagnostic method. It is conceivable that the new anomaly definitions could be contained in updates to the diagnostic method available for download from the remote analysis system.

Regarding the activity threshold, it can be fixed (and therefore be identical for all activity periods) or it can be variable depending on the activity period and/or the type of the construction site activity and/or the crane type.

According to an embodiment of the invention, for each activity period, the activity threshold for said activity period corresponds to an average value of the work times of several activity periods before said activity period, or after said activity period, or both.

Thus, the activity times of previous and/or subsequent periods are taken into consideration in order to set the activity threshold for the analyzed period.

Advantageously, the environmental data includes, in addition to the climatic data, topographical data representative of the surrounding topography of the construction site.

Indeed, such topographical data makes it possible to refine the local context of the construction site, to better understand the anomalies origins.

### BRIEF DESCRIPTION OF THE DRAWINGS

Other characteristics and advantages of the present invention will appear on reading the detailed description below, of a non-limiting example of implementation, made with reference to the appended figures in which:

FIG. 1 is a flowchart illustrating a diagnostic method of the invention;

FIG. 2 is a schematic view of an implementation of the diagnostic method in the context of determining one or more drop in activity periods among several activity periods of a distributing boom crane, by means of crane equipment and sensors, as well as an external system, transmitting crane data and environmental data to a remote analysis system which will process them with a view to said determination of drop in activity periods;

FIG. 3 illustrates a first example of application of the diagnostic method to identify and contextualize drop in activity periods among several activity periods; a variable activity threshold being used by the diagnostic method during a first processing to identify the drop in activity periods, and a first decision criterion being used during a second processing to determine whether the drop in activity periods are partly due to a material defect/malfunction of an equipment contributing to the lifting of a load by the crane;

FIG. 4 illustrates a second example of application of the diagnostic method to identify and contextualize drop in activity periods among several activity periods; a fixed activity threshold being used by the diagnostic method during the first processing to identify the drop in activity periods, and a second decision criterion being used during the second processing to determine whether the drop in activity periods are partly due to a material defect/malfunction of an equipment contributing to the lifting of a load by the crane;

FIG. 5 is an illustration of an example of a type of graph that can be displayed on a screen connected to the remote analysis system and serving as an analysis report following the processing carried out on the crane data and the work data with a view to determining one or more drop in activity periods; the graph corresponding to a hierarchical sunburst graph (a) representative of a drop in activity period for which the inner ring pieces (respectively the outer ring pieces) correspond to the anomalies (respectively to the subcategories anomaly associated with anomalies) defined in the diagnostic method; with here two examples of suspicious weeks such that for one of them all the defined anomalies and subcategories of anomaly were observed (b), and for the other some of the anomalies and subcategories of anomaly among all defined anomalies and subcategories of anomalies (c).

### DESCRIPTION

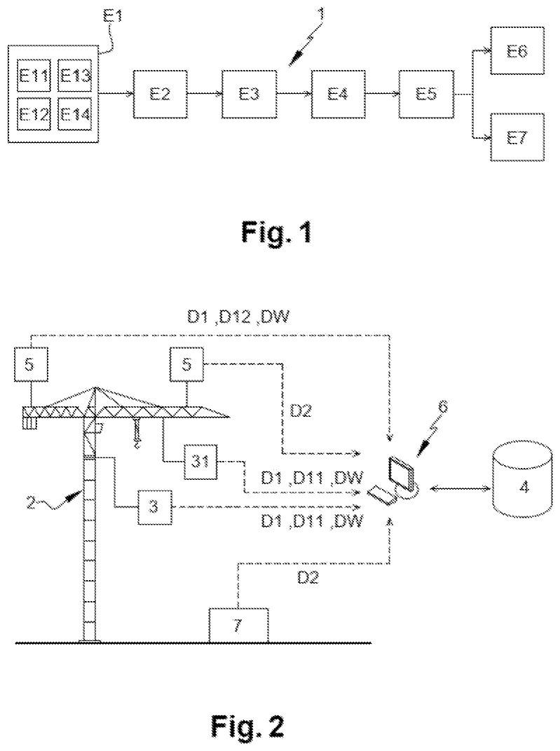

With reference to FIG. 1 to FIG. 4, the invention relates to a diagnostic method 1 of an activity of a crane 2, said diagnostic method 1, from an analysis of a plurality of data in relation to the crane 2 and its environment:
determine whether or not a drop in activity of the crane 2 happened or not during a given activity period AP, an activity period AP being for example a day, a week, a month. An activity period AP during which a drop in activity was observed is called a drop in activity period LAP;
in the case where a drop in activity period has been detected, determine and contextualize the causes, subsequently designated as anomalies A1, A2, A3, A4 at the origin of this drop in activity, then allowing the site managers to continuously improve their progress planning on material (with better equipment management for example) and/or human and/or logistical/organizational levels.

The diagnostic method 1 is applicable to all types of crane. In the context of the description, with reference to FIG. 2, it is considered that the crane 2 is a tower crane, more precisely a distributing boom crane.

With reference to FIG. 1 and FIG. 2, the diagnostic method 1 begins with a data detection and collection step E1 which comprises:
a detection E11 and a collection E13 of crane data D1 which comprise equipment data D11 coming from equipment 3, 31 of the crane 2, or sensor data D12 coming from sensors 5 installed on the latter;
a detection E12 and a collection E14 of environmental data D2 representative of the environment of the construction site in which the crane operates. The environmental data can be provided by a sensor 5 fitted to the crane; an external system 7 which is external to the crane 2 but installed on the construction site; or a system/entity external to the construction site (not shown in FIG. 2). As will be specified later, the environmental data may comprise climatic data providing information on the weather conditions to which the construction site is subjected. In this case, the external system/entity may correspond to a meteorological website providing climatic data relating to the country, and/or region, and/or city where the construction site is located.

The crane data D1, D11, D12 may comprise, non-limitingly/exhaustively:
data relating to the location of the structural, functional and ballast elements of the crane 2;
positioning data for the rise or fall of the block when lifting a load;
data representative of the presence or activity of a crane operator in the crane;
maneuver counting data;
data representative of a stop controlled by an anti-collision system.
   These data are sources of information for sites comprising several cranes, in particular if the circular working areas of the cranes 2 overlap because they make it possible to determine the frequency of the risks of collision between the booms of the cranes 2, and the frequency of stops of the cranes 2;
counting data of load lifting cycles;
data representative of pause time between two maneuvers;
data representative of maneuver types;
data related to the type and/or model of the crane 2 (for example, if the crane 2 is a tower crane: top-slewing crane, self-erecting crane, distributing boom crane, luffing boom crane . . . ). The type of crane is an important data because it is adapted to the environmental context of the construction site (fast-erecting cranes are used for individual constructions, while top-slewing cranes or self-erecting cranes for the construction of buildings . . . ). The usage guidelines are therefore different from one crane type to another;
etc.

The crane data D1, D11, D12 also comprise work data DW which is representative of a work carried out by the crane 2 such as, and non-limitingly/exhaustively, load/overload data when lifting a load; speed data of the maneuvered structural element (for example, a rotation speed of the boom).

The environmental data D2 includes at least climatic data such as temperature data, wind speed data and hygrometric data.

The environmental data D2 may also include topographical data representative of the surrounding topography of the site, for example: the presence of the site in a valley, the presence of neighboring buildings, etc.

In an embodiment of the invention, the collection E13, E14 of crane data D1, D11, D12, DW and environmental data D2 corresponds first of all to a recovery of the latter by the control-command system of the crane 2, which is therefore in communication with the equipment 3, 31 and sensors 5 of the crane 2, the external system 7. Once it has recovered them, the control-command system transmits the data from the cranes D1, D11, D12, DW and the environmental data D2 to a computer/IT infrastructure in charge of their processing for determining the drop in activity periods LAP of the crane 2 among a plurality of activity periods and the causes explaining them.

In a second embodiment of the invention, which corresponds to the described embodiment, the collection E13, E14 of crane data D1, D11, D12, DW and environmental data D2 corresponds to a direct transmission of said data D1, D11, D12, DW, D2 by the equipment 3, 31, the sensors 5, and the external system 7 to the IT infrastructure.

In the presented embodiment, the IT infrastructure comprises:
a remote analysis system 6 in communication designed to receive all of the data D1, D11, D12, DW, D2 and process them during processing E4, E5 for determining the drop in activity periods LAP of the crane 2 and their origin(s). The remote analysis system can for example correspond to a computer (desktop; or portable; or embedded/fanless type) which an operator (such as an analyst, the site manager, etc.) will use.
a remote database 4 in communication with the remote analysis system 6, and which is used for storing crane data D1, D11, D12, DW and environmental data D2.

In a variant of the invention, the remote database 4 is comprised in the remote analysis system 6.

In different embodiments of the invention, depending on the duration considered for the activity period, and the analysis needs of the site managers, the data D1, D11, D12, DW, D2 can be transmitted to the remote analysis system continuously or intermittently (transmission at the end of the day for example).

As the data D1, D11, D12, DW, D2 can come different types of equipment 3, 31; and/or sensors 5 of the crane 2; and/or external systems 7, they may have different formats. This is why the remote analysis system 6 proceeds, following the detection and collection step E1, to a data forming step E2 during which a cleaning and a structuring of the whole data D1, D11, D12, DW, D2 are implemented.

The data forming step E2 aims to make the data D1, D11, D12, DW, D2 more easily interpretable by the remote analysis system 6 when it subsequently carries out the processing E4, E5 thereon in order to determine the drop in activity periods LAP and their origins.

Indeed, the determination and analysis of the causes of an activity period AP as being or not a drop in activity period LAP are carried out a posteriori, once the activity period has temporally ended. The determination and analysis may also not be carried out immediately at the end of the activity period AP, but much later, after at least one other activity period AP has taken place. For example, if this activity period AP corresponds to the second week of a given month and a site manager wishes to determine whether the crane 2 has experienced a drop in activity over all the weeks making up the month in question, then the data D1, D11, D12, DW, D2 relating to this second week will only be processed at least at the end of the month.

Consequently, an historicization E3 is implemented following the data forming step E2, during which the data D1, D11, D12, DW, D2 will be historicized by activity period AP in the remote database 4 once the remote analysis system 6 has imported them there. Thus, if for example five specific activity periods AP must be analyzed among a plurality of activity periods, the remote analysis system 6 will only export the data D1, D11, D12, DW, D2 relating to said five activity periods AP.

Following the historicization E3 of the data D1, D11, D12, DW, D2 of at least one activity period AP are implemented at a time t the processing steps E4, E5 for its analysis.

In an embodiment of the invention, all or part of the processing E4, E5 are carried out directly by the remote analysis system 6 directly in the remote database 4.

In the presented embodiment, the processing E4, E5 are carried out only at the level of the remote analysis system 6, with export of all of the D1, D11, D12, DW, D2 which it needs to carry out the analysis of the considered activity period(s) AP.

Subsequently, the processing E4, E5 are referred to as first processing E4 and second processing E5.

During the first processing E4, a work time Ho of the crane 2 is calculated for at least one activity period AP studied from its associated working data DW, that is to say the time during which the crane was active/working during this one.

This work time Ho is then compared to an activity threshold. If the work time Ho of the studied activity period AP is lower than this activity threshold, then it is considered to be a drop in the activity period LAP.

In a first case, the activity threshold corresponds to a fixed value representative of an average time objectively determined by the construction site manager; meaning that an activity period AP is determined to be or not to be a drop in activity period LAP based solely on its associated work data DW.

In a second case, the activity threshold corresponds to a variable value, for example an average value of the work times Ho of several activity periods AP comprising: the activity period AP studied/of interest, and activity periods which are prior and/or subsequent to it. Consequently, in this second case, the first processing E4 is based on the analysis/processing of the working data DW from several activity periods AP to determine whether or not the activity period AP of interest is a drop in activity period LAP.

The second processing E5 is implemented in the case where a studied activity period AP (among or not a plurality of AP activity periods being processed) is identified as a drop in activity period LAP. The second processing E5 aims to contextualize the cause(s) explaining this drop in activity period LAP. For this, mathematical algorithms are applied to crane data D1, D11, D12, DW and environmental data D2, which compare them to decision criteria perceptible/understandable by the operator of the remote analysis system analyzing the activity period.

The decision criteria leading to the identification of a cause of a drop in activity can be defined based solely on an interpretation of the data D1, D11, D12, DW, D2 from the studied drop in activity period LAP; and/or the combined interpretation of several data sets D1, D11, D12, DW, D2 coming from the studied drop in activity period LAP on the one hand, and from several other activity periods AP on the other hand (whether or not these are drop in activity periods LAP).

Depending on the comparison results, the remote analysis system 6 determines that the cause causing the drop in activity of the crane during the drop in activity period corresponds to a type of anomaly A1, A2, A3, A4.

In the embodiment of the presented diagnostic method 1, four types of anomaly A1, A2, A3, A4 are defined:
an internal anomaly A1, and identified from crane data D1, D11, D12, DW including those listed previously;
a using anomaly A2 of the crane 2, also identified from crane data D1, D11, D12, DW;
a climatic anomaly A3 reflecting an extreme climatic condition associated with bad weather, and identified from climatic data comprised in the environmental data D2; and
an organizational anomaly A4; and identified from crane data D1, D11, D12, DW.

In each type of anomaly A1, A2, A3, A4, several subcategories (or natures) of anomaly A11, A12, A13, A21, A22, A31, A32, A41, A42 are also defined.

An internal anomaly A1 can correspond to a hardware fault A11, a software fault A12 or a communication fault A13 of faulty equipment 31 of the crane. This or these defect(s) may result from a malfunction or breakdown of equipment or a system due, for example, to lack of maintenance, a repair not carried out, or wear (the equipment or system reaching the end of its life).

The using anomaly A2 may correspond:
to a mounting anomaly A21 reflecting poor installation of the crane 2, and/or an adjustment of its structural, functional or ballast elements. For example, in order to meet the specific needs of the construction site, particular adjustments must be made to the elements and equipment of the crane 2 to perform additional functionalities. Yet, these adjustments may not have been anticipated before starting the construction site, implying that delays will occur at given times during the life cycle of the site to make these adjustments, otherwise it will not be able to move forward. The delays can also be caused by an unplanned change in the initial configuration of the construction site, with the emergence of new, previously unknown needs.
a controlling anomaly A22, that is to say an inappropriate controlling of the crane by the crane operator (lifting a load too quickly, rotating the boom too quickly, etc.).

The climatic anomaly A3 includes different subcategories of anomaly A31, A32 relating for example to the nature of the extreme climatic condition: strong gusts of wind A31; heavy rain A32; very high or very low temperatures.

Finally, organizational anomaly A4 may correspond to an activity anomaly A1 of the crane, that is to say the crane is inactive most of the time during the activity period AP with very little load to lift or displace (or in the worst case no load); or a management anomaly A2 due to an organizational lack in the management of the construction site, logistical delays, etc.

The decision criteria allowing the diagnostic method 1 to determine which type(s) of anomaly A1, A2, A3, A4 or subcategory(s) of anomaly A11, A12, A13, A21, A22, A31, A32, A41, A42 is/are the cause of a drop in activity period LAP are not limited in number.

According to different embodiments of the invention, one or more decision criteria is/are defined in the diagnostic method 1, and integrated into the remote analysis system 6, for the determination of the same type of anomaly A1, A2, A3, A4 or the same subcategory of anomaly A11, A12, A13, A21, A22, A31, A32, A41, A42.

According to his analysis needs, the user selects in the remote analysis system 6, during the second processing E5, the criterion(s) which appear to him to be the most relevant.

In an embodiment of the invention, an option is available in the remote analysis system 6 so that the user can define new decision criteria relating to a type of anomaly A1, A2, A3, A4 and/or or to a subcategory of anomaly A11, A12, A13, A21, A22, A31, A32, A41, A42, these new decision criteria being added to those already available in the remote analysis system (and which have been created by the creators of the invention), and then being used by the diagnostic method 1 during its execution.

In a second embodiment of the invention, the diagnostic method 1 can be enriched and improved, informing/defining new anomalies, that is to say which have never been encountered on the construction site. The definition of the new anomaly consists at least of informing at least one decision criterion which will be applied by the diagnostic method 1 during the second processing E5 of the crane data D1, D11, D12, DW and the environmental data D2 so that the drop in activity is identified as caused by this new type of anomaly.

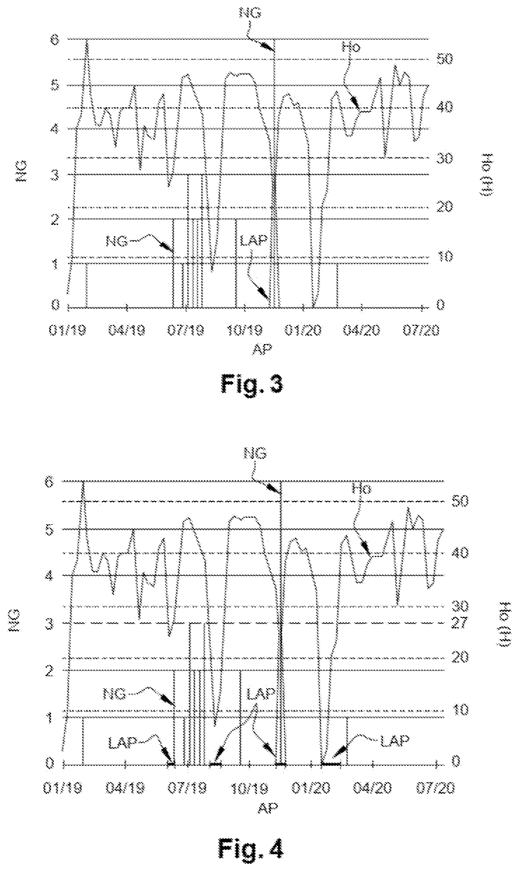

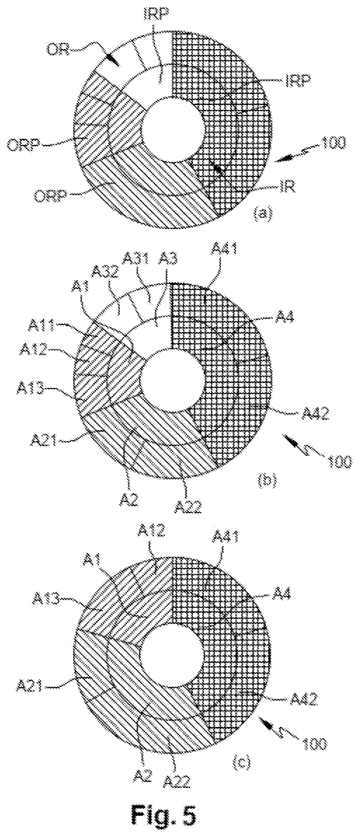

Two application examples of the diagnostic method 1 for the activity period AP analysis are presented and illustrated in FIG. 3 and FIG. 4. In these two examples, the activity of the crane 2 is analyzed for activity periods AP corresponding to weeks extending from January 2019 to July 2020.

For both examples, during the first processing E4, the work time Ho during which the crane 2 was active/working is calculated for each week/activity period AP, from the work data DW acquired by the remote analysis system 6 of the IT infrastructure during all of said weeks. The work time Ho is calculated and given in hours.

With reference to FIG. 3, in the context of the first application example, for each activity week/period AP, the activity threshold is defined as being equal to the average value between:
a first value equal to 0.7 times the average value of the work time Ho of the three weeks preceding a week considered among the several weeks, from which ten hours are subtracted; and
a second value equal to 0.7 times the work time Ho of the week following the week considered among the several weeks, from which ten hours are subtracted

If the work time Ho of a week among the several weeks of the activity period is greater than or equal to the activity threshold, then no drop in activity is observed by said week. If, on the contrary, the work time Ho for the considered week is below the activity threshold, then a drop in activity is observed for it, and the week is considered suspicious.

Thus, a drop in activity period LAP corresponds either to one suspicious week or to several consecutive suspicious weeks.

In order to determine the causes of the drops in activity of suspicious weeks detected during the first processing E4, the work time Ho for each activity week/period AP is compared with the crane data D1, D11, D12 associated with these suspicious weeks during the second processing E5, which were also noted for each activity week/period AP.

In the context of this first application example, the considered crane data D1, D11, D12 corresponds to the number of lifting faults NG due to a malfunction of a faulty equipment 31 contributing to the lifting of the load by the crane 2, which malfunction relates to an internal anomaly A1, more precisely to a hardware fault A11.

In order to determine whether the malfunction of the faulty equipment 31 is the cause of the drop in activity periods LAP, an average value, called the average lifting fault value NG, is first calculated, for at least one suspicious week comprised in a drop in activity period, between the number of lifting faults NG noted for the at least one suspicious week and that of the week preceding the at least one suspicious week.

A median value of the number of lifting faults NG is then calculated over all activity periods AP, namely between January 2019 and July 2020.

A decision criterion is then applied such that the malfunction of the faulty equipment 31 is one of the causes at the origin of a drop in activity period LAP of the crane when: the average lifting fault value NG of said drop in activity period LAP is greater than the median value of the number of lifting faults NG.

After application of this decision criterion, the diagnostic method 1 concludes that the malfunction of the faulty equipment 31 is partly at the origin of the drop in activity observed for a suspicious week between October 2019 and January 2020 (as a reminder, a drop in activity of a drop in activity period LAP can have a single or several origins).

With reference to FIG. 4, in the context of the second application example, the evolution of the work time of the crane over the activity period is compared to a fixed activity threshold which is equal to 27 hours.

A drop in activity period LAP is detected when the work time Ho becomes lower than the fixed activity threshold.

Four drop in activity periods are then identified:
a first drop in activity period LAP between April 2019 and July 2019,
a second drop in activity period LAP between July 2019 and October 2019,
a third drop in activity period LAP between October 2019 and January 2020, and
a fourth drop in activity period LAP between January 2020 and April 2020.

The crane data D1, D11, D12 considered during the second processing E5 for this second application example again corresponds to the number of lifting faults NG due to a malfunction of a faulty equipment 31.

In order to determine whether the malfunction of the faulty equipment 31 is the cause of the drops in activity over the four activity periods, the following criterion is applied: if the number of lifting faults NG is non-zero during a drop in activity period LAP, then the malfunction of the equipment partly explains the drop in activity observed during this drop in activity period LAP.

In this second application example, the diagnostic method 1 concludes that the malfunction of the faulty equipment 31 is a cause behind the drop in activity of the first and third drop in activity periods LAP. Indeed, two (respectively six) lifting faults NG are concomitant with the first (respectively the third) drop in activity period LAP.

However, no lifting fault NG was observed during the second and fourth drop in activity periods LAP, meaning that the malfunction of the faulty equipment 31 is not a cause at the origin thereof. Thus, the diagnostic method 1 must relate other crane data D1, D11, D12 and/or environmental data D2 with the work time Ho of the second and fourth drop in activity periods LAP to determine the causes explaining it.

In an embodiment of the invention, the operator can inform/define by means of the remote analysis system 6 of specific activity periods AP for which drops in activity are planned and known to the managers, for example the school holiday periods. If following the application of the first processing E4 a drop in activity period LAP is identified which coincides with a specific activity period AP, then the diagnostic method 1 does not consider it as a drop in activity period LAP but as a normal activity period AP.

In a first embodiment of the invention, the diagnostic method 1 implements, in parallel with the processing E4, E5 of the data D1, D11, D12, DW for each activity period AP, a display of a progress of said processing E4, E5 on a screen integrated into the remote analysis system 6 or connected to it.

In a second embodiment of the invention, new anomaly subcategories can be added to the predefined anomalies A1, A2, A3, A4 and to any new anomaly. The creation of a new anomaly subcategory also requires defining at least one decision criterion must be defined so that it is identified by the diagnostic method during the second processing E5.

In a third embodiment of the invention, it is possible that the definition of a new anomaly requires an evolution of the format used for the cleaning and the structuring of data D1, D11, D12, DW, D2, in the case where the new anomaly is determined from data presenting a format not currently taken into account by the diagnostic method 1 during the data forming step E2.

In a fourth embodiment of the invention, the addition of a new anomaly or a new subcategory of anomaly is carried out by the operator himself from the remote analysis system 6.

In a fifth embodiment of the invention, the addition of a new anomaly or a new subcategory of anomaly is carried out by the creators of the diagnostic method 1 on the basis of a customer feedback; the additions of anomaly or subcategory of anomaly are then part of an agile development approach for continuous improvement of the diagnostic method 1. It is possible that the new definitions of anomaly or subcategories of the anomaly are contained in updates of the diagnostic method 1 available for download and which can be downloaded from the remote analysis system 6.

Once the second processing E5 is completed, the remote analysis system 6 implements a generation E6 and/or a display E7 of an analysis report relating to the considered activity period(s) AP. This analysis report indicates in particular the drop in activity periods LAP identified as well as the anomalies A1, A2, A3, A4 and the anomaly subcategories A11, A12, A13, A21, A22, A31, A32, A41, A42 explaining it.

In a first embodiment, the analysis report can take the form of a file edited in a given format and comprising a complete detail of the processing and calculations carried out on the data D1, D11, D12, DW, D2 associated with one or more activity periods AP, and which led the diagnostic method 1 to identify among them one or more drop in activity periods LAP and the anomalies A1, A2, A3, A4 and subcategories of anomaly A11, A12, A13, A21, A22, A31, A32, A41, A42 explaining it.

In a second embodiment, the analysis report can be presented in the form of a visual representation, such as a graph 100 for example, so as to be quickly and easily interpretable and understandable by the operator of the remote system 6, especially if he is not an expert in data analysis. It is possible, for example, to display on the screen one or more graphs 100 associated respectively with one or more drop in activity periods LAP identified among several activity periods AP, with for each graph 100 a visual representation of the identified at least one type of anomaly A1, A2, A3, A4 and at least one subcategory of anomaly A11, A12, A13, A21, A22, A31, A32, A41, A42, for example: a color, text giving the name of the anomaly and associated with a color, etc.

For example, with reference to FIG. 4 is illustrated a hierarchical graph 100 called a sunburst graph for a drop in activity period LAP, with: the inner ring IR segmented into several inner ring pieces IRP corresponding to the anomalies A1, A2, A3, A4; and the outer ring OR segmented into several outer ring pieces ORP corresponding to the anomaly subcategories A11, A12, A13, A21, A22, A31, A32, A41, A42. The surfaces of each inner ring piece IRP (respectively of each outer ring piece ORP) are representative of the occurrence of the anomaly A1, A2, A3, A4 (respectively of the anomaly subcategory A11, A12, A13, A21, A22, A31, A32, A41, A42) during the drop in activity period LAP.

Thus, if during a drop in activity period LAP an anomaly A1, A2, A3, A4 or a subcategory of anomaly A11, A12, A13, A21, A22, A31, A32, A41, A42 has not been identified, it will not appear on the graph and the surfaces of the inner ring pieces IRP and the outer ring pieces ORP will adapt accordingly (since reflecting an occurrence of anomaly A1, A2, A3, A4 or anomaly subcategory A11, A12, A13, A21, A22, A31, A32, A41, A42).

In the example given in FIG. 4-b, all anomalies A1, A2, A3, A4 and anomaly subcategories A11, A12, A13, A21, A22, A31, A32, A41, A42 are identified for a first drop in activity period LAP, with a large part of the drop in productivity of the crane 2 being able to be explained by a lack of activity of the latter or organizational shortcomings concerning the construction site (nearly 50% of the drop in activity of the crane is due to an organizational anomaly A4).

In the example given in FIG. 4-c, internal anomalies A1, usage anomalies A2 and organizational anomalies A4 are identified for a second drop in activity period LAP. Compared to the first drop in activity period LAP, there was no climatic anomaly A3 during this one. Also, the internal anomalies A3 are only due to software A12 and communication A13 faults. It emerges from the analysis of this second activity period that the drop in activity of the crane 2 is mainly due to usage anomalies A2 (in particular controlling anomalies A22) and organizational anomalies A4.

In an embodiment of the invention, it is possible that the operator can interact with the graphic 100 displayed on the screen. For example, when clicking with a desktop mouse on a surface of an inner IRP or outer ORP ring piece, a new window is displayed on the screen and contains all the calculations and processing relating to the anomaly A1, A2, A3, A4 or the anomaly subcategory A11, A12, A13, A21, A22, A31, A32, A41, A42 associated with this surface.

1-15. (canceled)

16. The diagnostic method of an activity of a crane for a detection and a classification of a drop in activity period of said crane in a construction site among several activity periods (AP), said diagnostic method implementing at least the following steps:
detecting crane data coming from equipment of the crane, and comprising at least work data representative of a crane work implementing at least one maneuver of at least one structural element of the crane;
detecting environmental data representative of a construction site environment, and comprising at least climatic data;
logging by activity period of crane data and environmental data in a remote database;
for each activity period, processing the work data to calculate a work time of the crane during the activity period, and comparison of said work time with at least one activity threshold to determine whether said activity period is a drop in activity period or not;
for each drop in activity period, processing crane data and environmental data associated at least with said drop in activity period to identify at least one anomaly of the construction site or the crane, which anomaly being associated with said drop in activity period.

17. The diagnostic method according to claim 16, wherein the at least one anomaly comprises at least one internal anomaly of the crane reflecting a technical failure of the crane and identified from the crane data.

18. The diagnostic method according to claim 17, wherein the at least one internal anomaly (A1) comprises at least one hardware, software or communication fault of one of the equipment called faulty equipment, identified from crane data from said faulty equipment.

19. The diagnostic method according to claim 16, wherein the at least one anomaly comprises at least one use anomaly reflecting non-compliant use of the crane and identified from the crane data.

20. The diagnostic method according to claim 19, wherein the at least one use anomaly comprises at least one mounting anomaly reflecting a mounting, or an adjustment, or both, of equipment non-compliant or not suitable for the construction site, and identified from sensor data selected from crane data and coming from at least one sensor of the crane.

21. The diagnostic method according to claim 19, wherein the at least one use anomaly comprises at least one control anomaly reflecting non-compliant control of the crane by a crane operator during maneuvers, and identified from work data, such as for example speed data of at least one structural element of the crane or overload data.

22. The diagnostic method according to claim 16, wherein the at least one anomaly comprises at least one climatic anomaly reflecting an extreme and identified climatic condition from climatic data selected from environmental data.

23. The diagnostic method according to claim 16, wherein the climatic data comprise at least one of the following data: temperature data, wind speed data and hygrometric data.

24. The diagnostic method according to claim 16, wherein the at least one anomaly comprises at least one organizational anomaly reflecting low profitability of the crane usage and identified from crane data.

25. The diagnostic method according to claim 24, wherein the at least one organizational anomaly is identified from at least one of the following data among the crane data: data representative of a presence or activity of the crane operator in the crane, maneuver counting data, data representative of a stop controlled by an anti-collision system, cycle counting data load lifting, data representative of pause time between two maneuvers, data representative of types of maneuver, data representative of a crane type.

26. The diagnostic method according to claim 16, wherein a remote analysis system, in communication with or comprising the remote database, implements the processing of work data, crane data and environmental data to determine whether each activity period is a drop in activity period or not and to associate with each drop in activity period the at least one corresponding anomaly.

27. The diagnostic method according to claim 26, wherein the remote analysis system structures the crane data and the environmental data in a same predefined format.

28. The diagnostic method according to claim 16, wherein the diagnostic method implements, subsequent to the processing of crane data and environmental data of each drop in activity period, a generation, or a display, or both, of an analysis report comprising, for the or each drop in activity period, information specific to the at least one identified anomaly.

29. The diagnostic method according to claim 16, wherein, for each activity period, the activity threshold for said activity period corresponds to an average value of the work time of several activity periods before said activity period, or after said activity period, or both.

30. The diagnostic method according to claim 16, wherein the environmental data comprise, in addition to climatic data, topographical data representative of the surrounding topography.
